(19) United States
(12) Patent Application Publication
(10) Pub. No.: US 2016/0158806 A1
(43) Pub. Date: Jun. 9, 2016

(54) AUTOMATIC METHOD AND FACILITY FOR CHARACTERIZING AND/OR SORTING PACKAGES

(71) Applicant: PELLENC SELECTIVE TECHNOLOGIES (SOCIETE ANONYME), Pertuis (FR)

(72) Inventor: Antoine BOURELY, LA TOUR D'AIGUES (FR)

(21) Appl. No.: 14/908,424

(22) PCT Filed: Jul. 28, 2014
(86) PCT No.: PCT/FR2014/051949

§ 371 Date: Jan. 28, 2016

(30) Foreign Application Priority Data
Aug. 1, 2013 (FR) 1357657

(51) Int. Cl. B07C 5/34; B08B 3/10; B08B 3/04

(52) U.S. Cl. CPC B07C 5/3404; B08B 3/041; B08B 3/044; B08B 3/10

(57) ABSTRACT

Disclosed is an automatic method for characterizing and/or sorting packages, in particular bottle-type containers or similar, moving in a substantially planar flow and substantially without overlapping or mutual superpositioning, the flow including monolayer and multilayer packages (1). The method involves introducing a liquid fluid, in particular water or a liquid made from water, between the non-integral layers of the multilayer packages, detecting the presence of this interstitial liquid fluid in the multilayer packages using a contact-free detection system, and using the resulting information to characterize and/or sort the two types of packages (1).

This invention relates to a method and a system for the characterization and/or the sorting of monolayer and multilayer containers and/or packages.

Numerous methods have been developed for applications of automatic sorting of containers or packages.

This is the case in particular in the patent EP 1 243 350, in the name of the applicant, which describes a surface analysis system using infrared spectroscopy. This system makes possible the differentiation of objects of different categories such as different plastics (PET, PETG, PE, PP, PS, ABS, etc.). It is the spectroscopic analysis of the object that makes it possible to carry out this differentiation. The unit described in this European patent is of the back-scatter type; i.e., the light is emitted from top to bottom on a conveyor belt and the reading is done in an optical head located above the stream of products.

With these spectroscopic methods, the products that consist of different resins have different spectra, which make it possible to recognize them in a reliable way regardless of their physical appearance. Products whose upper layer is thicker give rise to longer optical paths for back-scattered rays, and it is therefore possible to partially detect these differences in thickness.

In the case of packages that contain beverages that are sensitive to external disruptions, it is often desired to create a barrier to gases that can circulate among the contents and the surrounding atmosphere: the barrier can target impermeability to oxygen, to carbon dioxide, or to other gases. Such a barrier is then produced in a nylon-type polymer (for example, the polyamide MxD6), but this polymer is not a good component for forming the entire package by itself (in particular because, in heavy thicknesses, it is not transparent).

A solution is then to use a tri-layer package, with external and internal layers made of PET (polyethylene terephthalate), as in the case of other beverage bottles, and the central layer of MxD6. The central layer is fine (approximately 10 μm), and the two PET layers are thicker (100 to 200 μm each).

During recycling of PET, for example, it is desired to preclude the presence of this nylon layer, which can affect the quality or the color of the recycled product. It therefore makes sense to separate out the multilayer bottles so that they do not contaminate the main stream (bottles exclusively made of PET) and subsequently to make them undergo a recycling treatment adapted to their situation.

There is therefore a need, and even a necessity, to sort the multilayers from monolayers, knowing that their external layer consists of the same material, generally PET, in the two cases.

If, in addition, account is taken of the relative thicknesses indicated above, even an analysis in the entire thickness of the bottle would provide only a slight percentage of the signal corresponding to the nylon layer (approximately 3%). This is why the optical sorting machines such as the one mentioned in the above-cited European patent do not detect significant differences between these materials.

However, color differences have been noted, with a greater opacity in the case of multilayers. This is reflected by the presence of a larger number of diopters: with two diopters per layer (one on each face), it is possible to expect that 5% of the optical signal will be reflected by each diopter. Therefore, a tri-layer package should reflect three times more than a monolayer, or at least two times more, if the intermediate layer is too fine. Actually, this effect is observed, but a reliable distinction is difficult to achieve.

An attempt has also been made to carry out laser-based sorting by using the multiple reflections created by these multiple diopters. However, this solution of necessity bumps into a simple obstacle: it is ineffective when the diopters disappear (products that are wet because of a previous washing phase).

Another visual difference between the two types of products is the yellowing of the nylon layer, which is nevertheless slight in view of the thickness of the layer in question.

The yellowing can also stem from the dirty water introduced during the washing phase (after evaporation, there is yellowed debris among the layers).

The applicant tried to base the sorting on the luminance differences mentioned above, associated with yellowing differences. However, she noted that this type of sorting has inadequate effectiveness, namely on the order of only half of the bottles when the yellowing is slight (washing with clean water).

To complete the description of the context of the invention, it should be noted that these monolayer and multilayer packages, in particular when they are bottles, can be covered by a sleeve that acts as a label, over a portion or the entire height thereof, as well as the monolayer bottles found in the same streams. The first stage of the regeneration therefore consists in making them pass into a machine to remove the sleeves, or “label stripper” (also known under the designation “bottle stripper”). The operating principle of these machines is to slash the outer faces of the bottles for several minutes to tear and remove the sleeves. During this operation, the surfaces of the bottles are damaged (cuts, slits, punctures), and the walls are partially or totally pierced. The stoppers and the collars of the necks are often destroyed.

Within this context, the object of the invention is to provide a more reliable and more repetitive solution for specifically automatically recognizing the multilayer packages or containers, in a passing stream that contains mixed monolayer and multilayer packages or containers, made of similar or different materials.

In addition, the proposed solution should be able to be integrated without significant modification in the known method and system for characterization and sorting, in particular by the above-cited document EP 1 243 350, and by preserving, if possible, the same measuring and detection technology. Ideally, the invention should not require any additional material means for its use in existing sorting/characterization systems, in particular those using the conventional near-infrared spectroscopy for the detection of chemical signatures of the constituent materials of the packages or containers going by.

For this purpose, the invention has as its object an automatic method for characterization and/or sorting of packages, in particular bottle-type containers or the like, passing in a stream that is essentially planar and essentially without mutual superposition or overlapping, with said stream comprising monolayer and multilayer packages,

method characterized in that it consists in introducing a liquid fluid, in particular water or a water-based liquid, among the non-integral layers of the multilayer packages, in detecting the presence of this interstitial liquid fluid in the multilayer packages by a contact-free detection system, and in using the resulting information to perform the characterization and/or the sorting between the two types of packages.

The invention also has as its object an automatic facility for characterization and/or sorting packages for the implementation of the method described above comprising at least one label stripper, a washing station, a contact-free detection system, as well as a means ensuring that said packages pass by flat (i.e., essentially over a single layer) at the level of the detection zone,

facility characterized in that it also comprises a means exploiting the informational signals provided by the detection system for distinguishing the monolayer packages relative to the multilayer packages based on the information regarding whether interstitial liquid is present or not.

The invention will be better understood, owing to the description below, which relates to a preferred embodiment, provided by way of non-limiting example and explained with reference to the accompanying diagrammatic drawings, in which:

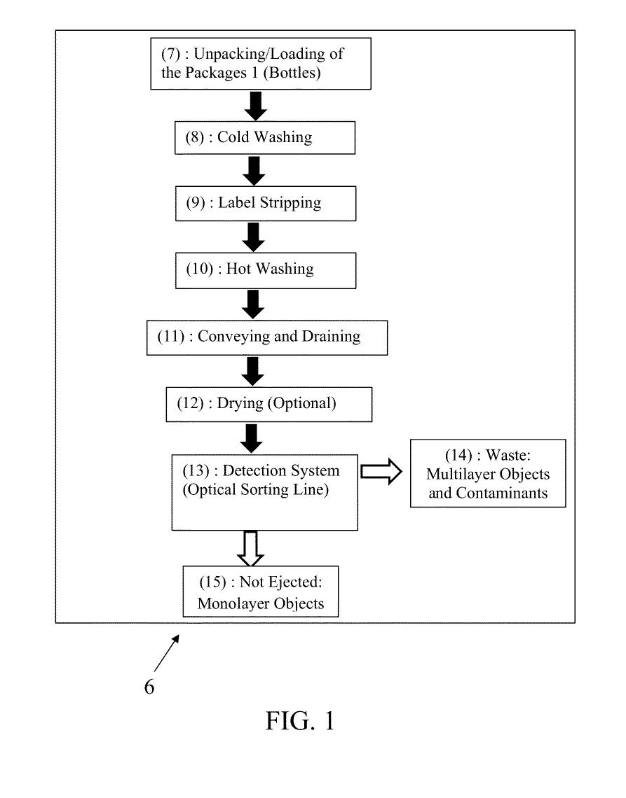

FIG. 1 is a flow chart that illustrates the primary stations of a facility for implementing the method according to an embodiment of the invention (each unit of the block diagram corresponding both to a station and an operating stage);

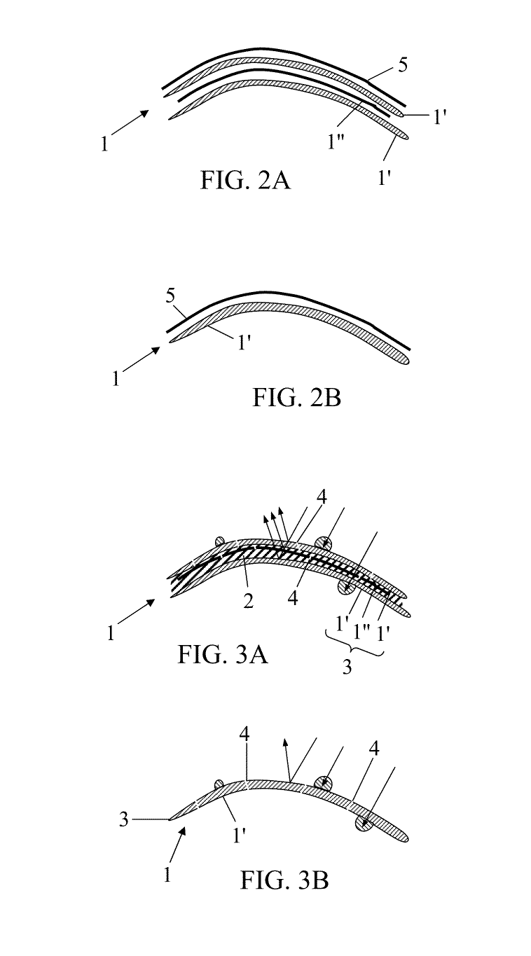

FIGS. 2A and 2B are partial cutaway views of the walls of monolayer and multilayer bottles in the dry state and with their labels, and

FIGS. 3A and 3B are partial cutaway views that are similar to those of FIGS. 2A and 2B of the same walls of bottles during their inspection by the detection system, after having been subjected to stripping and washed.

In the first place, the invention relates to an automatic method for characterization and/or sorting of packages, in particular bottle-type containers or the like, passing in a stream that is essentially planar and essentially without mutual superposition or overlapping, with said stream comprising monolayer and multilayer packages 1.

In accordance with the invention, the method consists in introducing a liquid fluid 2, in particular water or a water-based liquid, among the non-integral layers 1′, 1″ of the multilayer packages, in detecting the presence of this interstitial liquid fluid 2 in the multilayer packages by a contact-free detection system 13, and in using the resulting information to perform the characterization and/or the sorting between the two types of packages 1.

Preferably, the introduction of a water-based liquid fluid 2 among the layers 1, 1″ of the multilayer packages 1 is carried out during a preliminary washing operation of all of the packages to be characterized and/or sorted.

So as to facilitate even further the differentiation of the two types of above-cited containers/packages 2, it is advantageously provided that the washing phase (or similar phase for introducing water among the separate layers of the multilayer walls) is followed by a preferably controlled draining phase, before the detection phase, and optionally an active surface drying phase.

To ensure a rapid and reliable introduction of liquid, in particular washing liquid, into the containers 2 and for the multilayer containers among the layers 1′, 1″, the invention provides an adequate preparatory treatment. Thus, before the phase of introducing liquid fluid 2, all of the packages or containers 1 are subjected to an operation of slashing or piercing the walls 3 of said packages 1 in such a way as to create similar through slits or cut-outs 4 in the walls.

Preferably, the operation of slashing or piercing the walls of packages is carried out by a label stripper 9.

Thus, the invention takes advantage of two existing stages for the treatment of the containers 1 and does not add any additional stage for the preparation of the containers 1 for the purposes of discrimination between monolayer and multilayers.

Relative to the technology for detection of interstitial liquid, multiple variants can be provided, all based on techniques that are known to one skilled in the art. Thus, the contact-free detection system can use, for example:
Near-infrared spectroscopy;
Hyperfrequency waves absorbed by the liquid 2;
X-rays absorbed by the liquid 2.

As is evident from the disclosure above, this invention takes advantage of an important physical property of the multilayer bottles 1 and more generally numerous multilayer packages: since the layers 1′, 1″ do not adhere to one another, they fill with water during washing (in general a dwell time of several minutes in near-boiling water), and especially easily since the prior passage of bottles into the label stripper 9 created multiple slits 4 at least on the surfaces (external layers) of the walls of these bottles.

Leaving washing station 10, the outside surfaces of all of the bottles drain, including for the monolayers, and their internal water content escapes. In contrast, the water 2 that is introduced among the layers 1′, 1″ remains trapped by capillary action and remains there for a very long time. Tests performed by the applicant showed that the interstitial water content remains high beyond 4 hours after the washing, even by setting bottles to ambient temperature on a dry support.

However, the near-infrared signature of the water is particularly strong (just as for X-rays or hyperfrequency waves of suitable wavelength): under these conditions, a PET-and-water combination is therefore detected if, and only if, the bottle is multilayer. The result can be applied, of course, to polymers other than PET.

More specifically, there is an essentially continuous layer of interstitial water 2 between the layers 1′, 1″ of the walls 3, whereas on the outer and inner faces of said walls, only residual drops remain (see FIGS. 2 and 3).

To optimize this effect, there is a desire to extend the draining phase, and even to add a brief drying period (for example by an industrial radiant) on the surfaces of bottles: the drying has time to act only on the upper layer 1′, and not between the layers. In the best case and with optimal adjustment, the invention even makes it possible to sort bottles that are dry on the surface but wet on the inside, but only if they are multilayer.

An advantageous observation can be made in relation to certain conditions of use of the invention. Actually, if the stripper 9 has malfunctioned on certain bottles, the label 5 can remain, in its entirety or partially. An interstitial water layer can then get in between the label 5 and the wall 3 of the bottle. The water remains trapped for a longer time than on a bare bottle (approximately 15 to 20 minutes), but for a shorter time than in the interior of a multilayer. Detection carried out within a short time after the washing therefore runs the risk of confusing a multilayer bottle with a bottle with a label.

It is found that this consequence is rather favorable: a residual label 5 is a defect (and therefore the bottle that bears it is a contaminant), since an attempt is made to remove it in advance with the stripper. If the detection system 13 confuses the two categories, it will trigger the ejection of the two types of contaminants.

The invention also relates to an automatic facility 6 for characterization and/or sorting of packages for implementing the method described above, comprising at least one label stripper 9, a washing station 8, 10, a contact-free detection system 13, as well as a means 11 ensuring that said packages 1 pass by in a monolayer at the level of the detection zone.

This facility 6 is characterized in that it also comprises a means exploiting the informational signals provided by the detection system 13 for distinguishing the monolayer packages 1 relative to the multilayer packages 1 based on the information regarding whether interstitial liquid 2 is present or not.

By way of nonlimiting example, an embodiment of the facility is described below, in connection with FIG. 1, which shows—in the form of a block diagram—the main stages or stations of a unit or facility for organized regeneration and sorting 6 according to the principle of the invention, optimized for bottles 1 containing a large proportion of plastic sleeves 5.

In such a unit, in practice, the products 1 arrive in bales from the package sorting centers and are unpacked and then arrive at the loading station 7 on the line: they are loaded, for example, via an endless screw.

First of all, they undergo a first cold washing stage (station 8) with cold water. This stage is designed to remove from them paper labels and surface contamination: soil, sticky or greasy food residue. They then pass into the label stripper 9 that removes 90 to 95% of the sleeves 5.

This stripper in general consists of a hollow drum with an inside diameter of 80 cm to 1 m and whose inside face is covered by cutting lugs. The bottles rotate in the stripper for several minutes. The label fragments that are thus torn off are evacuated away from the washing line. The various cuts or slits 4 created on the surfaces of the bottles will facilitate the subsequent penetration of water.

The following stage is hot washing (station 10), at 95° C. and with in general a highly basic detergent. The object this time is to wash the interiors of the bottles integrally and to remove the glue residue on the surfaces. Again, this is a drum filled with hot water, in which the bottles rotate and stay for several minutes. The multilayer bottles are filled with water among the different layers 1′, 1″.

The bottles are then taken up by a conveying system 11 that has, among others, the role of emptying them of their water content and draining them on the surface. In general, at more than 97%, they are completely emptied. In contrast, the water contained among the layers adheres well by capillary action and is not evaluated or very little is evacuated.

Optionally, to optimize the effectiveness of the method of this invention, it is possible to add a drying stage (station 12) after the draining and on the sorting belt 11. This drying stage uses industrial radiants that provide a brief thermal flash on the surfaces of the bottles and that can be combined with fans. This makes it possible to have bottles that are almost dry on the surface, at least for the upper or outside face.

Finally, the products that are to be inspected are accelerated on the conveyor of an automatic sorting and detection system to speeds on the order of 3 m/s, before reaching the optical sorting line 13 itself. The latter contains one or more cascade sorting system(s) or machine(s), each of which eliminates the defects or contaminants by blowing them out of the main line, for example downward at the end of the sorting conveyor.

The waste exhaust (station 14) then contains the material contaminants (all of the bottles that are not made of the desired polymer) and in particular the multilayers, which are made of several different materials.

The exhaust of non-ejected products (station 15) contains the bottles of pure and often colorless material. They will then undergo grinding to be reduced into flakes, and then optionally other chemical stages before ending up in the form of granules that can constitute new products, and in particular new bottles. This last process is named BTB (“bottle to bottle”) in English and constitutes the recycling process of the highest quality level.

Optionally, a first sorting upstream from the stream of packages could be carried out to supply the facility 6 with packages 1 that it can distinguish.

FIGS. 2A and 2B respectively show a dry multilayer wall portion and a dry monolayer wall portion. For the monolayer, it is possible to have a PET layer with a thickness of 200 to 350 For the multilayer, it is possible to have an outside layer of 150 to 200 μm (for example, PET), an intermediate nylon layer of 10 μm, and an inside layer of 100 to 150 μm (for example, PET).

FIGS. 3A and 3B show the same wet products.

Water droplets dispersed randomly on the surfaces of the bottles, on the outside face or the inside face, are seen there. However, since polymers are in general hydrophobic, water does not wet them and concentrates in the form of isolated drops on the surface. As soon as the thickness of one drop reaches 1 mm or more, almost all of the signal is absorbed through said drop. The zone of the drop therefore contributes very little to the signal read by the optical detection system. In contrast, on both sides of these drops, the infrared signal is almost identical to that of a dry product.

In the case of multilayers, in contrast, a continuous film of water 2 forms between the two main layers 1′, and the infrared light necessarily passes through it. The thickness of this film of water (in general) is estimated at approximately 20 μm, and its infrared signature is very significant because the absorbance of water is very high. This effect is even greater for rays that have reached the lower face of the bottle (inside layer 1′) because they pass through two layers of water before returning toward the optical sensor.

The clear signals received by the sensor of the detection system are therefore respectively close to those of a dry product for the monolayer and are heavily influenced by water for the multilayer, thus allowing a reliable discrimination based on this criterion.

Of course, the invention is not limited to the embodiment described and shown in the accompanying drawings. Modifications remain possible, in particular from the standpoint of the composition of the various elements or by substitution of equivalent techniques, without thereby exceeding the scope of protection of the invention.

1. Automatic method for characterization and/or sorting of packages, in particular bottle-type containers or the like, passing in a stream that is essentially planar and essentially without mutual superposition or overlapping, with said stream comprising monolayer and multilayer packages (1),
the method consisting in introducing a liquid fluid (2), in particular water or a water-based liquid, among the non-integral layers (1′, 1″) of the multilayer packages, in detecting the presence of this interstitial liquid fluid (2) in the multilayer packages by a contact-free detection system (13), and in using the resulting information to perform the characterization and/or the sorting between the two types of packages (1).

2. Method according to claim 1, wherein the introduction of a water-based liquid fluid (2) among the layers (1′, 1″) of the multilayer packages (1) is carried out during a preliminary washing operation of all of the packages to be characterized and/or sorted.

3. Method according to claim 2, wherein the washing phase is followed by a draining phase, before the detection phase.

4. Method according to claim 1, wherein before the liquid fluid introduction phase (2), all of the packages or containers (1) are subjected to an operation for slashing or piercing the walls (3) of said packages (1) in such a way as to create similar through slits or cut-outs (4) in the walls.

5. Method according to claim 4, wherein the operation for slashing or piercing the walls of the packages is carried out by a label stripper (9).

6. Method according to claim 1, wherein the contact-free detection system (13) uses near-infrared spectroscopy.

7. Method according to claim 1, wherein the contact-free detection system (13) uses hyperfrequency waves that are absorbed by the liquid (2).

8. Method according to claim 1, wherein the contact-free detection system (13) uses X-rays absorbed by the liquid (2).

9. Automatic facility (6) for characterization and/or sorting packages for the implementation of the method according to claim 1 comprising at least one label stripper (9), a washing station (8, 10), a contact-free detection system (13), as well as a means (11) ensuring that said packages (1) pass by in a monolayer at the level of the detection zone,
the facility also comprising a means exploiting the informational signals provided by the detection system (13) for distinguishing the monolayer packages (1) relative to the multilayer packages (1) based on the information regarding whether interstitial liquid (2) is present or not.

10. Method according to claim 2, wherein before the liquid fluid introduction phase (2), all of the packages or containers (1) are subjected to an operation for slashing or piercing the walls (3) of said packages (1) in such a way as to create similar through slits or cut-outs (4) in the walls.

11. Method according to claim 3, wherein before the liquid fluid introduction phase (2), all of the packages or containers (1) are subjected to an operation for slashing or piercing the walls (3) of said packages (1) in such a way as to create similar through slits or cut-outs (4) in the walls.

12. Method according to claim 2, wherein the contact-free detection system (13) uses near-infrared spectroscopy.

13. Method according to claim 3, wherein the contact-free detection system (13) uses near-infrared spectroscopy.

14. Method according to claim 4, wherein the contact-free detection system (13) uses near-infrared spectroscopy.

15. Method according to claim 5, wherein the contact-free detection system (13) uses near-infrared spectroscopy.

16. Method according to claim 2, wherein the contact-free detection system (13) uses hyperfrequency waves that are absorbed by the liquid (2).

17. Method according to claim 3, wherein the contact-free detection system (13) uses hyperfrequency waves that are absorbed by the liquid (2).

18. Method according to claim 4, wherein the contact-free detection system (13) uses hyperfrequency waves that are absorbed by the liquid (2).

19. Method according to claim 5, wherein the contact-free detection system (13) uses hyperfrequency waves that are absorbed by the liquid (2).

20. Method according to claim 2, wherein the contact-free detection system (13) uses X-rays absorbed by the liquid (2).
